(19) United States
(12) Patent Application Publication
(10) Pub. No.: US 2010/0090851 A1
(43) Pub. Date: Apr. 15, 2010

(54) ELECTRICAL EXTENSION CORD

(76) Inventor: Bruce Hauser, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/571,251

(22) Filed: Sep. 30, 2009

Related U.S. Application Data
(60) Provisional application No. 61/101,393, filed on Sep. 30, 2008.

(51) Int. Cl. G08B 21/00; H01R 11/00

(52) U.S. Cl. 340/657; 439/505

(57) ABSTRACT

An electrical extension cord to conduct and provide electrical power to multiple locations on a job site includes a power supply portion having an electrical connector configured to be received in an electrical outlet that provides a source of electricity. The extension cord includes a power distribution portion having at least a first electrical cord and at least a second electrical cord with each cord having an electrical connector configured to receive a mating connector of an electrically powered device and the extension cord further includes a junction that electrically couples the power supply portion and the power distribution portion with the coupling being enclosed by a housing. The first cord and the second electrical cord define a length of at least six feet measured from the housing.

### CROSS-REFERENCE TO RELATED APPLICATIONS

This application claims the benefit of U.S. Provisional Application No. 61/101,393, which was filed on Sep. 30, 2008. The entirety of the priority application is hereby incorporated by reference.

### BACKGROUND OF THE INVENTION

1. Field of the Invention

The present invention relates to electrical distribution devices and, more particularly, to an electrical extension cord device.

2. Description of the Related Art

Electrical extension cords, in particular electrical power cord strips having single input and multiple output, allow for increased utility of available electrical power sources. The typical commercial or residential building electrical outlet includes one or two electrical sources. An electrical power cord strip provides a plurality of typically female connectors for a plurality of devices to connect to for proper electrical power source. In particular, in industrial applications, where heavy duty equipment and tools requires high electrical load capability, durability, and mobility available to several working areas within a general workplace area, the availability of numerous uncluttered female electrical plugs can improve efficiency, workability, and safety.

A variety of electrical cord extension and power strip devices currently exist. A primary challenge of known devices such as those disclosed in U.S. Pat. No. 6,486,407 and U.S. Pat. No. 7,229,302, is the ability to provide electrical sources for electric heavy duty equipment and tools from a single source dispersed to several of said equipment and tools at the same time and spread out about a general and/or elevated location. For example, in a construction zone where electrical power sources may be limited and multiple users of a variety of different tools require direct electrical power sources at a ground level and/or at an elevated platform level.

An additional short-coming with the noted electrical extension cords is the clustering of a number of extension cord male-female plug couplings adjacent the common workplace as the individual electrical appliances are plugged into the female connectors in an immediate local vicinity of the electrical extension cord housing 118. Such a clustering presents safety concerns due to the close proximity of manipulable electrical couplings and the increased trip hazards presented by the collection of close proximity electrical couplings.

The aforementioned devices consist of source electrical cords arranged to transmit electrical power to a housing that distributes to short proximate cords terminating with female electrical connectors and lacking the ability to provide uncluttered electrical power to a large work area, particularly an elevated work area. As a result, these electrical extension cord devices must rely on the tool or equipment cord being routed to a central hub or housing 118, rather than the extension cord source plug being directly routed to the specific working location within the general work area. Or alternatively, such an electrical setup requires the need of several individual extended length electrical extension cords to connect between a power strip and the noted tools or equipment. Further, the electrical power cords on such tools and equipment do not come in standard lengths and are generally of short length. Use of such tools and equipment can lead to a local cluttering effect within or adjacent to working areas and/or the need for additional extension cords to reach from the power cord strip to multiple specific working locations.

### SUMMARY OF THE INVENTION

Accordingly, there is a need in the art for an improved electrical extension cord device that solves some of the disadvantages discussed above, that provides sufficiently length-wise extended electrical cords, allows sufficient user separation between the extended electrical cords, and provides a durable and reliable electrical extension cord device for use in an industrial or manufacturing environment such as construction. Further, a need exists for an improved electrical extension cord that mitigates the need for numerous extended length extension cords for the use of a plurality of industrial tools or equipment in the same general locality, workplace, or work zone.

Accordingly, one embodiment of the invention includes an electrical extension cord to provide electrical power to multiple locations on a job site having a power supply portion with an electrical connector configured to be received in an electrical outlet that provides a source of electricity, and a power distribution portion for delivering power to one or more electrically powered devices. The power distribution portion includes a first electrical cord having an electrical connector configured to receive a mating connector to a first of the one or more electrically powered device, the electrical cord having a first end and a second end, the second end terminating in the electrical connector, and a second electrical cord having an electrical connector configured to receive a mating connector to a second of the one or more electrically powered device. The electrical extension cord further includes a junction that electrically couples the power supply portion to the power distribution portion, the junction having a housing that encloses the coupling between the power supply portion and the distribution portion, and wherein the housing receives the second end of the power supply portion, the first end of the first electrical cord, and the first end of the second electrical cord, wherein each of the first electrical cord and the second electrical cord define a length of at least six feet measured from the housing.

In another embodiment, the invention includes a power indicator in electrical communication with the power supply portion and is configured to be in a first state when subject to electrical power, and in a second state when not subject to electrical power. Another embodiment can further be configured wherein the power indicator is located within the housing and provides an external visual change in appearance when changing states. Yet another embodiment can have the first electrical cord and the second electrical cord have a length ranging from six to twelve feet.

In yet another embodiment, the invention includes an electrical extension cord to provide electrical power to multiple locations on a job site having a power supply portion with an electrical connector configured to be received in an electrical outlet that provides a source of electricity, and a power distribution portion for delivering power to one or more electrically powered devices. The power distribution portion includes a first electrical cord having an electrical connector configured to receive a mating connector to a first of the one or more electrically powered device, the electrical cord having a first end and a second end, the second end terminating in the electrical connector, and a second electrical cord having an electrical connector configured to receive a mating connector to a second of the one or more electrically powered device. The electrical extension cord further includes a junction that electrically couples the power supply portion to the power distribution portion, the junction having a housing that encloses the coupling between the power supply portion and the distribution portion, and wherein the housing receives the second end of the power supply portion, the first end of the first electrical cord, and the first end of the second electrical cord, wherein the first electrical cord and the second electrical cord are greater in length than the power supply portion, and each of the first electrical cord and the second electrical cord define a length of at least six feet measured from the housing.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is a perspective view of an electrical extension cord in accordance with an embodiment of the present invention.

FIG. 2 is a schematic view of the electrical extension cord of FIG. 1.

FIG. 3 is a schematic view of another electrical extension cord in accordance with an embodiment of the present invention.

FIG. 4 is a schematic view of another electrical extension cord in accordance with an embodiment of the present invention.

FIG. 5 is a schematic view of another electrical extension cord in accordance with an embodiment of the present invention.

### DETAILED DESCRIPTION OF THE PREFERRED EMBODIMENT

The associated drawings and specification discuss aspects and features of the present invention in the context of several different embodiments of electrical power extension cords that are configured for concurrent multi-appliance use about an extended working area. Discussing these features in connection with construction applications provides clarity and consistency in presenting these inventive features and concepts. However, it is to be understood that the features and concepts discussed herein can be applied to industries other than the construction industry. For example, extended length extension cords can be applied to other industrial applications such as manufacturing, wood-working, or the like.

In fact, the principles discussed herein can be used in any application that would benefit from an electrical extension cord having a broad radial range that reduces the number of external extension cords required about an extended working area involving industrial tools and/or equipment. While Applicant specifically provides examples of use of these principles in accordance with such stated industries, Applicant contemplates that other applications may benefit from this technology.

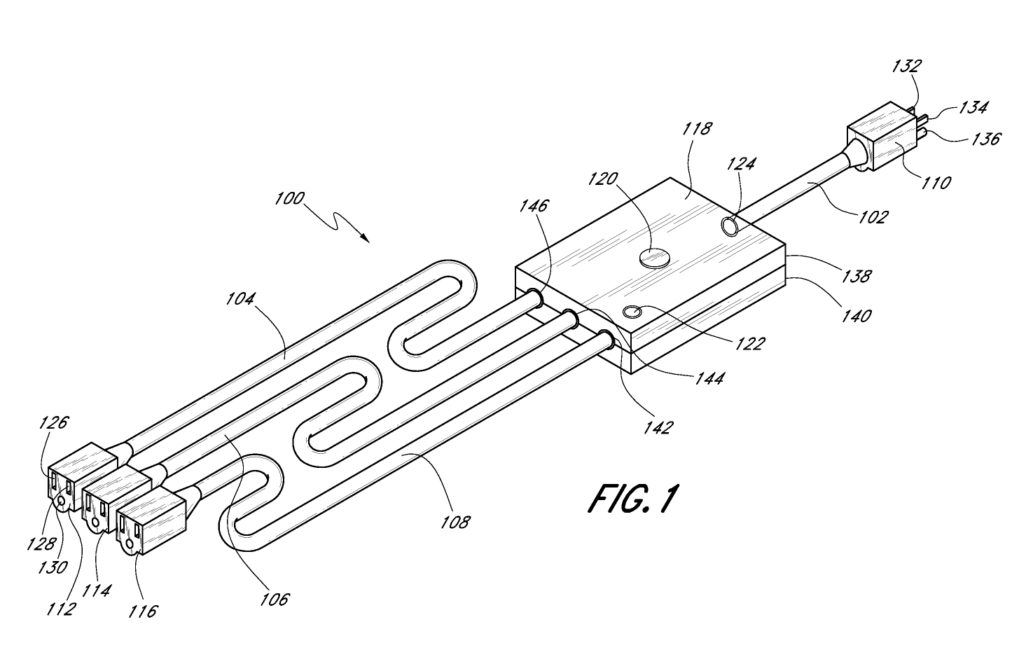

With reference to FIG. 1, a perspective view of an electrical power extension cord 100 device is shown. The electrical power extension cord 100 device provides the capability to distribute high load electrical requirements across a large working area. The electrical power extension cord 100 generally includes a first electrical member 102, a housing 118, a second electrical member 104, a third electrical member 106, and a fourth electrical member 108. The electrical members 102, 104, 106, otherwise referred to as electrical cords, are generally configured to receive, conduct, and/or output electrical power, or electricity.

The first cord 102 includes a proximal end and a distal end. The proximal end of the first cord 102 is coupled to a first electrical connector 110, otherwise referred to as a male plug, and the first cord's distal end is coupled to the housing 118. The second cord 104, third cord 106, and fourth cord 108 similarly include a proximal end and a distal end. The second, third, and fourth cords, otherwise referred to as distal cords, include a second electrical connector 112, a third electrical connector 114, and a fourth electrical connector 116, respectively, that are coupled to the distal ends of the respective distal cords. Thus, the housing 118 couples the distal end of the first cord 102 to the proximal ends of the second cord 104, third cord 106, and fourth cord 108. Alternatively, the extension cord 100 can include more or less than three distal cords that have a proximal end that is coupled to the distal end of the housing 118.

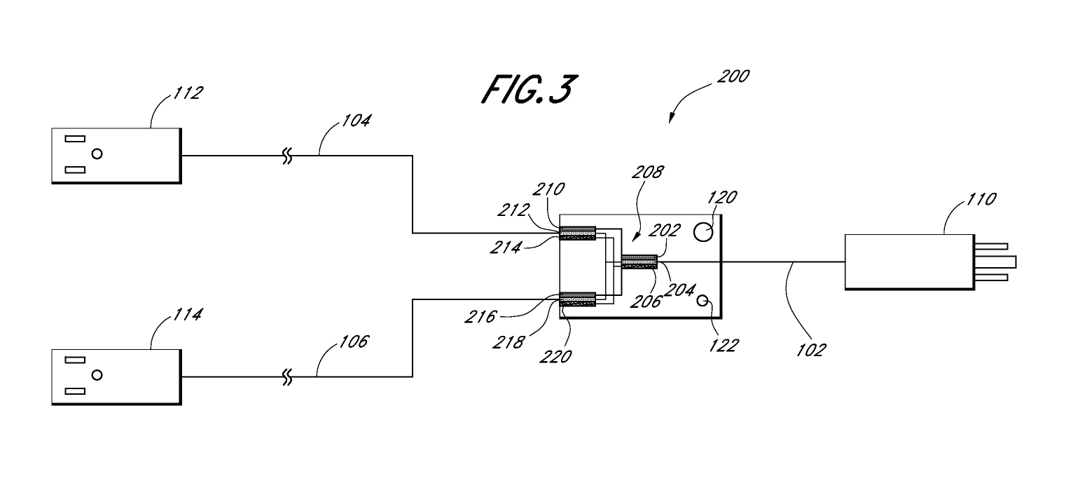

With reference to FIGS. 1-3, the first cord 102 includes an electrical connector 110 and a cable that comprises the elongate portion of the first cord 102. The cord, or cable, elongate portion typically includes three conductive elements 202, 204, 206, and insulator material, and a sheath, which are not shown in the figures. The conductive elements, otherwise referred to as wires, extend the full length of the first cord 102 from the electrical connector 110 to the housing 118. Alternatively, any number of wires can be included to make the cable or elongate portion of the first cord 102, e.g. one or more wires.

With reference to FIGS. 1-3, the electrical connector 110 of the first cord is shown. The electrical connector 110, otherwise referred to as a male plug, includes three prongs and a receptacle. The receptacle, or plug, is coupled to the proximal end of the first cord 102 at the distal end of the plug 110. The male plug 110 is configured to receive electrical power, or electricity, from an electrical source, thus the three prongs of the plug 110 are configured to be received by a female electrical source. The three prongs are generally in the form of two different shapes. The first prong 132, or first neutral prong 132, and the second prong 134, or first positive prong 134, are generally a narrow, flat blade having a rectangular cross section. The third prong 136, or first ground prong 136, is generally a round pin. Alternatively, the male plug 110 can include any number of prongs and variety of prong geometries, e.g. one or more legs, round, square, long, short, or the like.

The male prongs 132, 134, 136, regardless of shape or quantity, protrude outward from the plug 110, typically in a proximal direction away from the plug 110 and away from the elongate portion of the cord 102. The male prongs can be comprised of a rigid metal material, e.g. steel, brass, or the like. And the metal prongs may further be protected with a metallic coating, e.g. zinc, tin, nickel, or the like. Alternatively, the male plug 110 can have the protrusion of the male prongs extend in any direction, as dictated by specific purpose, materials, or the like, required of the electrical power extension cord 100 device.

The typical electrical outlet has three apertures, in a general triangular shape, with a lone round aperture at one corner and two narrow rectangular apertures that are parallel to each other at the remaining two corners. Accordingly, the orientation of the male legs on the male plug are similarly oriented and spaced in a triangular geometry. The electricity is transmitted, or conducted, distally through the first cord, corresponding to the electricity being transmitted through, for example, the first positive wire within the first cord.

With continued reference to FIGS. 1-3, the electrical power cord 100 device in the illustrated embodiment is configured to receive electricity from an external source. Transmission of electricity through the electrical power extension cord 100 initiates at the male plug 110, typically when the male prongs 132, 134, 136 are received by a female electrical outlet. The male plug, including the at least one narrow blade prong, and/or the round pin leg are received by a typical electrical outlet, such as that existing in a conventional workplace, residential building, or the like. The ground prong 136 is generally longer than the positive prong 134 and neutral prong 132, so the device is grounded before the power is connected. The neutral prong 132 in the male plug 110 is wider than the live one to prevent polarized male plugs from being inserted incorrectly. Some plugs can have both pins narrow, or the same size, since the ground prong 136 will ensure that proper polarity is maintained.

The first cord 102 includes the three wires, otherwise referred to as a first neutral wire 202, a first positive wire 204, and a first ground wire 206. The first neutral wire 202, first positive wire 204, and first ground wire 206 all similarly extend from the proximal end of the first cord 102 at the male plug 110, or electrical connector, to the distal end of the first cord 102 at the housing 118. The distal end of the three wires generally terminate adjacent an inner portion of the housing 118. An alternative embodiment can include a first cord that continues into the proximal end of the housing 118 and extends out of the distal end of the housing 118 to establish one of the second, third, or fourth distal electrical cords, as discussed in detail below. Within the housing 118 of such an embodiment, the proximal ends of the other two distal electrical cords are coupled to the first cord to establish electrical communication.

The three wires, the first neutral wire 202, the first positive wire 204, and the first ground wire 206 are coupled to the male plug 110. More specifically, the individual wires are individually coupled to the male prongs 132, 134, 136 that protrude from the male plug 110, such that the first positive wire 204 is coupled to the first positive prong 134, the first neutral wire 202 is coupled to the first neutral prong 132, and the first ground wire 206 is coupled to the first ground prong 136.

With continued reference to FIGS. 1-3, the wires 202, 204, 206 of the first cord 102 can be made of any conductive material, typically a conductive metal, e.g. copper, aluminum, or the like. The individual wires are generally a solid single piece wire, however, they can also be made out of a plurality of smaller diameter wires that are bundled together to create a single larger effective wire or multiple wires spliced together. The wires can further be plated with an alternate metal, e.g. zinc, tin, or nickel, to provide added protection against oxidation of the wire surfaces. Alternatively, the wires can be made from any other conductive material suitable for the purposes of the electrical power cord 100 device.

The three wires 202, 204, 206 extending from the proximal end of the first cord 102 to the distal end of the first cord 102 are generally parallel to each other. However, along the full length or a portion of the first cord 102, the wires can be arranged in a variety of configurations. The wires can be separated or joined by a sheath, holding the three wires together, or the wires, as a particular configuration is dictated, can be a twisted set or formed in any other geometric combination shape extending from the proximal end to the distal end of the first cord.

The three wires will be substantially the same length, and variation in length is provided at the distal end upon entry to the housing 118, allowing for varying individual wire lengths to achieve adequate coupling to the proximal ends of the corresponding wires of the distal cords 104, 106, 108 within the housing 118. The corresponding wires as described would be the corresponding neutral, positive and ground wires that comprise the elongate portions of each of the distal cords 104, 106, 108.

The first cord 102 extends distally a desired length, typically in the range of two to four feet, and in a preferred embodiment extends a length of three feet. However, the first cord is capable of varying from a length of zero to any desired length. The male electrical connector 110, or the male plug prongs 132, 134, 136, simply protrude from a portion of the housing 118 when the first cord 102 has no tangible length; thus, no first cord 102 is implemented, just the described male prongs, as illustrated in the embodiment of FIG. 5.

With continued reference to FIGS. 1-3, the individual wires 202, 204, 206 of the first cord 102 also have a layer of insulating material, not shown in the figures, individually disposed about the outer diameter surface of each wire. The insulator material has dielectric properties that electrically isolate the individual wire. The individual wires can also have, in conjunction with or instead of the insulators, a protective conductor jacket, and/or a protective sheath. The insulating material, the protective jacket, and the protective sheath are flexible, protective, and electrically non-conductive, e.g. thermoplastic, vinyl, Teflon, silicone rubber, polyethylene, polyvinylchloride, polypropylene, or the like. The insulators can comprise such materials either alone or in combination. Alternatively, any number of the wires, in any combination, can have no insulator material disposed about the outer diameter surface, such that the bare wire is implemented into the first cord.

A conductor jacket over the primary insulation may be considered when additional mechanical protection is desired. The conductor jacket acts as a mechanical barrier and prevents shorting between the conducting wire and a shield. The conductor jacket material can be nylon, vinyl, or the like. Such conductor material provides tensile strength, impact and flexural strength, resistance to abrasion, good electrical properties, and chemical resistance.

A shield may be provided to protect the high voltage wires, to act as a conductor, or to protect from external excitations, and can be comprised of braided copper wire, copper and aluminum tapes, aluminum/polyester or aluminum/glass laminates, plastics, conductive glass, any variation or combination therein, or the like. The shield can be applied to the individual conductors and/or the overall arrangement of conductors within the cord.

The wires of the first cord are then contained, or bundled, within an outer protective cover that holds the wires and insulators together and protects against damage due to handling and use. The protective cover material is durable, non-conductive, and flexible, e.g. rubber, vinyl, or the like.

With continued reference to illustrated embodiment of FIGS. 1-3, the second 104, third 106, and fourth 108 distal electrical cords are similar to the first cord 102 in arrangement and construction with two exceptions, associated with the length of the distal cords and the electrical connector. The distal cords 104, 106, 108 are considerably longer than the first cord 102. The second, third, and fourth cords are typically in the range of six to twelve feet, but can be longer or shorter as required by the desired application. Advantageously, the extended length of the distal cords 104, 106, 108 provide for simultaneous electrical source capability by a single extension cord to a broad wide-ranging workspace area that can include a plurality of spaced apart work locations. Thus, in a construction zone, several tools and/or equipment can be in use at the same time working several discrete tasks across a wide area. Additionally, the extended length cords advantageously provide for a plurality of electrical sources to elevated work areas, such as on a raised platform, raceway, tower, or the like. Further, the extended length cords can provide electrical power to locations at different elevations, e.g. to an elevated platform and ground level simultaneously, or the like. The extended length distal cords also advantageously preclude the need to carry numerous extended length electrical extension cords to a job worksite, as the electrical power extension cord 100 provides for the equivalent function of a plurality of extension cords, as well as a power strip to couple the alternative of several individual electrical extension cords. In an illustrated embodiment, a ten foot length for the distal cords establishes a twenty foot radius of electrical source capability, significantly increasing the allowable workspace with electrical tools and/or equipment. The proximal first cord 102 is three feet in length and advantageously provides the ability for the male plug to couple to a standard electrical source outlet, that is typically adjacent the ground, or floor, and allow the housing 118 to rest safely and evenly on the ground during use.

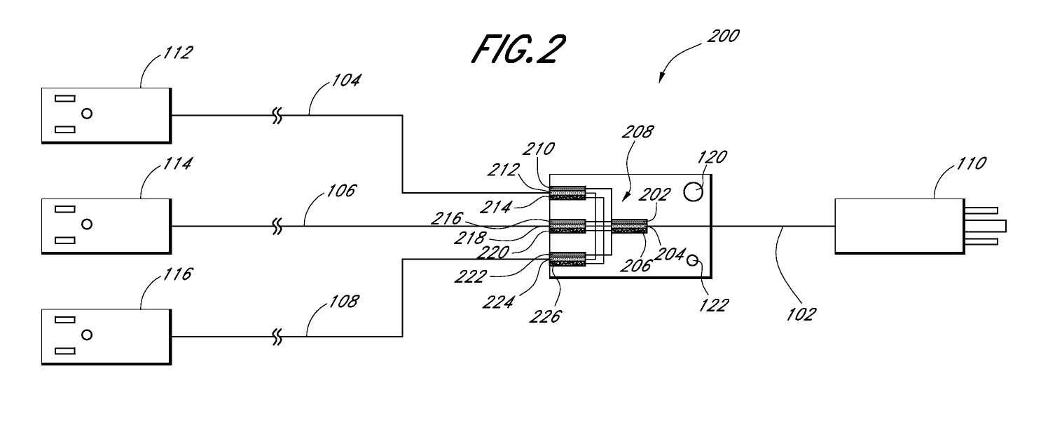

With further reference to FIG. 2, as noted above, the second cord 104, the third cord 106, and the fourth cord 108 are constructed similarly to the first cord 102. The second cord includes a second positive wire 212, a second neutral wire 210, and a second ground wire 214. The third cord 106 includes a third positive wire 218, a third neutral wire 216, and a third ground wire 220. The fourth cord 106 includes a fourth positive wire 222, a fourth neutral wire 224, and a fourth ground wire 226. Each individual wire, or collection of at least two wires, can be encased or enclosed by an insulating and/or electrically conductive or non-conductive material, or more specifically, as the embodiments are described in more detail above.

With further reference to FIG. 1, the second cord 104 has a proximal end and a distal end. The proximal end is coupled to the housing 118, extending through a second aperture 142 in the housing 118. The portion of the proximal cord contained within the housing 118 is that portion of the second cord that is coupled, as described above, to the first cord. The second positive, neutral, and ground wires are electrically coupled, and in electrical communication with, the first positive, neutral, and ground wires of the first cord 102, respectively. The distal cords electrical connectors, otherwise referred to as a female plug or an electrical outlet, includes a plug body which further includes receptacles configured to receive a male plug that is similar to the first cord's male plug, described in further detail below.

With continued reference to FIGS. 1-3, the electrical connectors 112, 114, 116 for the distal cords 104, 106, 108, respectively, are shown. The electrical connectors, otherwise referred to as a first female plug 112, a second female plug 114, and a third female plug 116, on the three distal cords are of a female configuration. The female plug 112 is generally shaped like a common type B plug, having two parallel rectangular apertures and a round ground or earth aperture, in a triangular shaped layout on the distal end of the female plug.

A first rectangular aperture 128 is configured to couple with a positive prong of a male plug at the distal end and the positive wire of the distal second cord 104 at the proximal end of the female plug. Similarly, a second rectangular aperture 126 is configured to couple to a neutral male prong at the distal end of the female plug and to the neutral wire of the distal second cord 104 at the proximal end of the female plug. Accordingly, a third aperture 130 is partially round shaped and is similarly configured to be coupled to a round ground prong on the distal end of the female plug 112 and the ground wire of the distal second cord 104. Alternatively, any shape and orientation of neutral, positive and ground connector elements can be used to form the female electrical connector. Accordingly, the remaining distal electrical connectors, or plugs 114, 116, include a corresponding arrangement of neutral, positive, and ground connector elements.

The extension cord, more particularly the proximal male plug, is configured to couple to an electrical source. Thus, the male plug can couple to an electrical source such as a typical electrical outlet in a home, commercial building, or warehouse, where a standard electricity source is available. Alternatively, the male plug can be configured to couple to a generator, a solar, a wind or a hydro-electric power source.

With continued reference to FIGS. 1-3, the electrical extension cord device as described provides for capability to receive and distribute a 20 amp electrical source and a 125 volt electrical source. However, the electrical extension cord 100 device can be configured to see and distribute electrical sources having an unlimited range of source amperage and voltage magnitude combinations.

The coupling of the first cord to the second cord, third cord, and fourth cord is contained in the housing 118, that can optionally be a hermetically sealed electrical connector. The hermetically sealed electrical connector can be made of a water resistant and electrically non-conductive material such as rubber, plastic, Teflon, polyurethane or the like.

With continued reference to FIGS. 1-2, the housing 118 is shown. The housing 118 includes a top shell 138 and a bottom shell 140. The top shell 138 and bottom shell 140 are coupled together to form an enclosing structure. The inner portion of the housing 118 structure includes the electrical communication coupling established between the wire 202, 204, 206 of the first cord and the three distal power cords 104, 106, 108, the second, third, and fourth cords. Within the housing 118, similarly charged or conductive wires of the first cord are coupled to similarly charged or conductive wires of the second, third, and fourth cords. Such that, for example, the first positive wire is coupled within the housing 118 to the second, third, and fourth positive wires of the distal cords.

Alternative embodiments or configurations for the housing 118 can be achieved within the scope of the disclosed extension cord device. For example, the housing 118 can be made of a single integral piece, or may include more than two pieces to comprise a complete housing 118. Further, the pieces of the housing 118 can be rotatingly or flexibly hinged, typically about an edge of a mating surface. Such a hinged configuration can provide additional simplicity to the mating of the housing 118 shell pieces, easing the assembly and/or disassembly of the housing 118 and electrical extension cord 100 device.

With continued reference to FIGS. 1-3, the housing 118 inner portion conductive wiring arrangement ensures that like wires between two cords are electrically coupled and are capable of transmitting the electricity which is received from an external electrical source at a proximal end through to the plurality of female plugs at the distal ends of the outlet cords in the electrical power extension cord device.

The three wires 202, 204, 206 of the first cord 102, are configured to couple within the housing 118 so that the source electricity is transmitted to the distal end of the distal cords 104, 106, 108 to be provided to the user. The internal configuration of the housing 118 provides for a routing of the wires of the first cord to be coupled to the corresponding wires of the distal cords. The coupling can comprise various mechanical connections, e.g. fastener, soldering, welding, mechanically wrapping, sleeved containment, twisted pair between corresponding wires being coupled, by coupling to a common conductive material at a common connection location, electrically clipping or clamping wire ends, groove and detent fastening, or the like. When both wires are coupled to the distribution location, the electricity is fully capable of being transmitted from the first wire to the second wire.

With continued reference to the illustrated embodiments of FIGS. 1-3, the electrical coupling provides for an electrical distribution network such that the second cord 104, third cord 104, and fourth cord 108 can be electrically coupled to the first cord 102. The distribution arrangement provides for the individual wires of the first cord to electrically communicate in such a manner that the first positive wire 204 has a distal end arranged to provide at least three distal electrical communication paths, each of the at least three distal paths are configured to couple to a second 212, a third 218 and a fourth 224 positive wire associated with the second cord 102, third cord 104, and fourth cord 108, respectively, in a distal direction. Similarly, the first neutral wire 202 and the first ground wire 206 are configured to be electrically coupled to the corresponding neutral and ground wires of the second, third, and fourth distal cords.

The coupling of the first cord 102 to the second cord 104, the third cord 106, and the fourth cord 108 can be configured to be located at a single junction or a plurality of junctions. The coupling establishes a distribution of the electricity received and transmitted from the electrical source. The coupling additionally provides an even distribution and prevents overload of any one electrical cord in the electrical extension cord device.

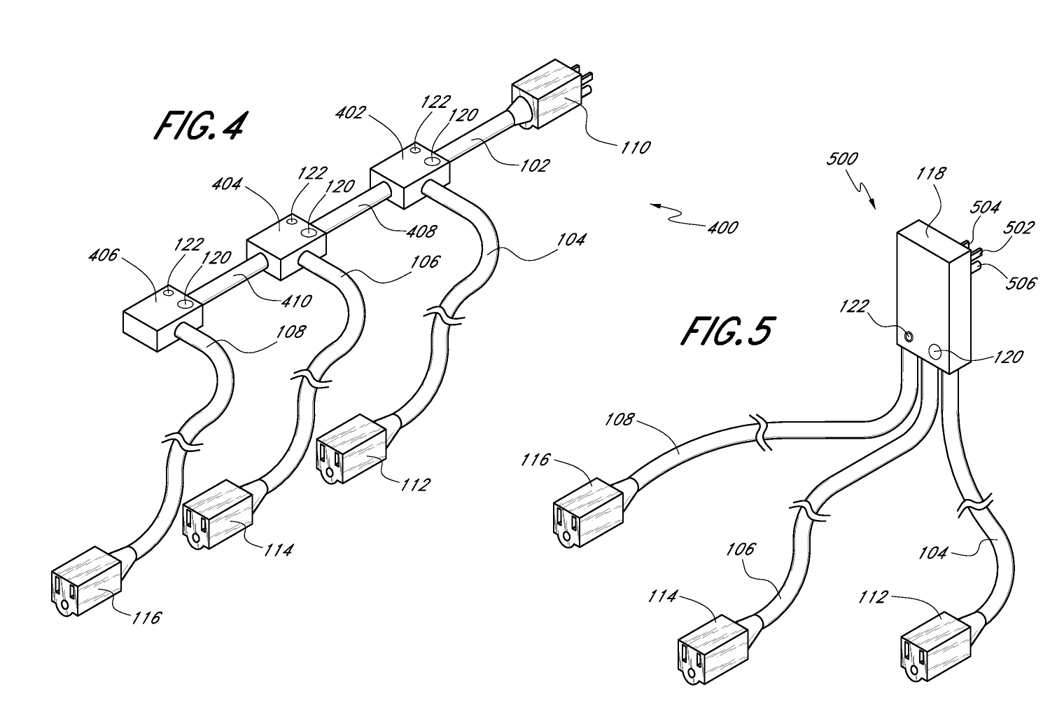

A single junction provides for all of the like named wires to be coupled together at one distributed network. An embodiment including multiple junction locations for each distal cord provides for the first cord 102 wires to connect to the like named wires of the second, third, and fourth distal cords at more than one distinct location, e.g. the connections occur in series rather than in parallel. Establishing the couples in series advantageously provides for the second, third, and fourth distal cords to be separated such that they are not directly adjacent to each other, as shown in the embodiment of FIG. 4.

In an alternative embodiment, the coupling of the first cord 102 wires 202, 204, 206 to the distal cords can further include a splitting of each of the wires into three unique wires. The splitting can occur by physical separation of a bundled collection of wires that comprise each of wires 202, 204, 206. Each of the distal cords individual wires as described above can then be coupled to the three split portions of each of the wires 202, 204, 206.

In an alternative embodiment, the wires 202, 204, 206 continue through the housing 118 to itself form one of the distal cords. Two additional coupled wires, coupled in a mechanical fashion to the first wire 102, establish two distal cords and the continued first cord 102 establishes a third distal cord. Thus, one of the distal cords is a unitary cord system, integrally connected to the first cord 102, and simply routed through, in a pass through manner, a proximal aperture and a distal aperture of the housing 118.

The electrical extension cord 100 housing 118 can be further configured to include additional capabilities such as a power source indicator, a fuse, a switch, or the like. Such additional capabilities provide for safety features, safe and reliable continued implementation and use of the electrical extension cord device, ease of use for a user of the device, and multi-functional application of the electrical cord device.

With further reference to FIGS. 1-3, a switch 120 and a power indicator 122 are shown. The housing 118 further includes the switch 120, and the power indicator 122, or a combination thereof. The switch 120, which can be provided as a single switch or a plurality of switches, is used to control the conduction of electricity from the first cord to the second cord and/or the third and fourth cords. In the illustrated embodiment, shown with one switch 120, the single switch 120 controls the power/electricity to the plurality of distal cords 104, 106, 108. When the switch 120 is actuated to the ‘on’ position, electricity is conducted through the housing 118 to the distal cords. Conversely, when the switch is actuated to the ‘off’ position, the electricity conductive path is broken or temporarily broken such that electricity will not be conducted through the housing 118 from the first cord 102 to the second, third, and fourth cords.

Alternatively, the housing 118 can include a plurality of switches 120 that can control, via actuation, flipping, remote control, or the like, an individual switch associated with an individual cord such that the flipping or actuating of the switch initiates or terminates the conduction of the electricity from the first cord 102 and the housing 118 through to the associated distal cord. In one embodiment, a switch 120 is associated with the distal second cord 104, and can be switched to the ‘on’ position such that the second distal cord will have electricity conducting through the housing 118 toward the distal end first female plug 112 of the second cord 104.

However, if the switch is actuated to the ‘off’ position, the electricity to the second cord can be individually and uniquely terminated such that no electricity conducts through to the second cord 104, but electricity can continue to conduct or transmit through to the third cord 106 and the fourth cord 108, where the third cord 106 switch 120 and the fourth cord 108 switch 120 are in the ‘on’ position. Accordingly, the same description of on/off control applies to the third and fourth cord, when a plurality of switches associated with the individual distal cords exist in an arranged configuration of the embodiment.

With further reference to FIGS. 1-3, a power indicator 122 is shown. The power indicator 122 is included on the housing 118 and provides a visual indication to a user that electrical power is being conducted through the housing 118 and the internal wiring or other components located within the inner portion of the housing 118. The power indicator 122 includes an LED light in electrical communication with the extension cord 100 device. The LED light can be coupled to the extension cord at any point in the system, e.g. in the first cord or the housing 118 prior to the split in the electrical transmission to the distal power cords, or at any or all of the individual distal outlet power cords after the split. Alternatively, a plurality of lights can provide similar information concurrently with respect to various locations within the system. The power indicator 122 LED light provides a safety feature, as well as provides assistance in troubleshooting possible malfunctions. The safety feature lets users know when an outlet power cord is live, or hot, or conducting electricity, whereas troubleshooting informs the user what portions of the power cord device is or is not functioning properly if errors are encountered in the electrical output of the system.

An overload protective device, not shown in the figures, can be included in the electrical power extension cord. The overload protective device, otherwise referred to as a fuse, a circuit breaker, a capacitor, a conditioner, or the like, regulates the electricity in the extension cord device. The conditioner device responds to a surge in current and/or voltage in the system to protect the elements of the system from damage or premature deterioration due to such a surge occurrence. The conditioner device may be located in the housing 118 inner portion, electrically coupled to the wires of the first cord. In such a manner, the conditioner regulates the electrical power from the source, providing protection for all distal power cords, the second, third, and fourth cords. Alternatively, the conditioner device can be located anywhere else in the electrical extension cord device, e.g. in the first cord, or individually attached to each of the distal outlet power cords, the second, third, and fourth cords.

The housing 118 can further include a mechanism to securingly hold the distal cords in a compact state for storage. The mechanism can include a plurality of arms to wrap the extended length distal cords around, e.g. in a circular direction. The storage mechanism can be just one set of arms or a plurality of arms, providing an individual set of storage arms for each distal cord. Alternatively, the housing can include a winding arm that can provide a shaft to wrap the distal cords around, which is coupled to a manually driven handle or an electrically driven actuator that will rotate the shaft in either a winding or unwinding direction to either store or use the distal electric cords 104, 106, 108 of the electrical power extension cord 100.

With continued reference to FIGS. 1-3, a first aperture 124 is shown. The housing 118 includes generally at least one aperture 124 configured to receive at least one cord, the first cord 102. The second aperture 142, the third aperture 144, and the fourth aperture 146 are configured to receive the three distal cords. In the illustrated embodiment, the proximal end of the housing 118 is configured with a first aperture 124, where the first aperture 124 extends through the housing 118 body, occurring at the interface between the top shell 138 and the bottom shell 140. The top shell 138 and the bottom shell 140 each include a semicircular cut-out along a common mating edge, and the semicircular cut-outs substantially align along the mating edge. The resulting aperture 124 is sized to substantially fit the outer diameter or surface of the first cord 102. The aperture 124 can also have a protective material, that can be conductive or dielectric, disposed about the aperture edges, depending upon the desired application and extension cord characteristics. Alternatively, the apertures 124, 142, 144, 146 can be located at any location in the housing providing outer to inner access, and the apertures can be shaped to any desired geometry provided the required sealing and/or protective capability is achieved.

The housing 118 can include an individual aperture for each of the cords passing through the housing. However, a single aperture comprising all of the distal cords, the second, third, and fourth cords in the illustrated embodiment, can be configured or arranged to pass through the housing 118. Such a configuration advantageously allows for the distal cords to separate and split off individually outside of the housing 118.

With continued reference to FIGS. 1-3, the apertures for both the first, second, third, and fourth cords are sufficiently hermetically sealed from the environment. The aperture pass through holes can also be electrically sealed using insulating material similar to the material used for the insulating of the individual wires, as described above. The insulator material is configured to be fixedly located between the outer diameter of the first cord 102 and the inner diameter of the first aperture 124 formed by the semi-circular cut-out in the housing 118 top shell 138 and bottom shell 140. The apertures are accordingly sized to snugly fit around the cord, or collection of cords, that pass through the housing 118 apertures. The sizing for the snug fit accounts for the material that might be used for the insulating or conducting/non-conducting material. The insulating material itself can also be electrically conductive.

With reference to FIG. 4, another embodiment of an electrical power extension cord 400 having a spaced distance between distal cord junctions is shown. The electrical power extension cord 400 includes a distal second cord 104, a third cord 106, and a fourth cord 108 that are electrically coupled at individually unique locations to the electrical source being transmitted from a proximal first cord 102. The unique locations, a first junction 402, a second junction 404, and a third junction 406 are spaced apart and electrically couple via a first spacer cord 408 and a second spacer cord 410, respectively. The spacer cords 406, 408 are similarly constructed to cords 102, 104, 106, 108 as described above. The lengths of the spacer cords can vary as required by the desired application of the electrical power cord 100 device. Alternatively, the spacer cord 410 can be the same electrical cord portion as cord 108, eliminating the need for the third junction 406. The individual junctions can similarly include the switch 120, power indicator 122, and/or the protective overload feature as described in detail above, either alone or in combination.

With reference to FIG. 5, yet another embodiment of electrical power extension cord 500 having a proximal electrical connector 510, or male plug, that is directly protruding from a portion of the housing 118 is shown. The electrical power extension cord 500 does not include an elongate portion of the proximal cord 102, rather only the male plug 510 is provided. The male plug 510 includes a positive prong 502, a neutral prong 506, and a ground prong 506 that are similarly sized and configured as described above with reference to male plug 110. The electrical power extension cord 500 advantageously eliminates the elongate portion of the proximal cord 102, reducing the geometric foot print of the cord 500.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. An electrical extension cord to provide electrical power to multiple locations on a job site comprising:
a power supply portion having an electrical connector configured to be received in an electrical outlet that provides a source of electricity;
a power distribution portion for delivering power to one or more electrically powered devices comprising:
a first electrical cord having an electrical connector configured to receive a mating connector to a first of the one or more electrically powered device, the electrical cord having a first end and a second end, the second end terminating in the electrical connector;
a second electrical cord having an electrical connector configured to receive a mating connector to a second of the one or more electrically powered device;
a junction that electrically couples the power supply portion to the power distribution portion, the junction having a housing that encloses the coupling between the power supply portion and the distribution portion, and wherein the housing receives the second end of the power supply portion, the first end of the first electrical cord, and the first end of the second electrical cord;
wherein each of the first electrical cord and the second electrical cord define a length of at least six feet measured from the housing.

2. The electrical extension cord of claim 1, further comprising a power indicator in electrical communication with the power supply portion and configured to be in a first state when subject to electrical power, and in a second state when not subject to electrical power.

3. The electrical extension cord of claim 2, wherein the power indicator is located within the housing and provides an external visual change in appearance when changing states.

4. The electrical extension cord of claim 1, wherein the first electrical cord and the second electrical cord have a length ranging from six feet to twelve feet.

5. The electrical extension cord of claim 1, wherein the proximal electrical member comprises an electrical connector directly coupled to the housing without the use of a power cord between the electrical connector and the housing.

6. An electrical extension cord to provide electrical power to multiple locations on a job site comprising:
a power supply portion having a power supply cord and an electrical connector configured to be received in an electrical outlet that provides a source of electricity;
a power distribution portion for delivering power to one or more electrically powered devices comprising:
a first electrical cord having an electrical connector configured to receive a mating connector to a first of the one or more electrically powered device, the electrical cord having a first end and a second end, the second end terminating in the electrical connector;
a second electrical cord having an electrical connector configured to receive a mating connector to a second of the one or more electrically powered device;
a junction that electrically couples the power supply portion to the power distribution portion, the junction having a housing that encloses the coupling between the power supply portion and the distribution portion, and wherein the housing receives the second end of the power supply portion, the first end of the first electrical cord, and the first end of the second electrical cord;
wherein the first electrical cord and the second electrical cord are greater in length than the power supply cord, and each of the first electrical cord and the second electrical cord define a length of at least six feet measured from the housing.

7. The electrical extension cord of claim 6, further comprising a power indicator in electrical communication with the power supply portion and configured to be in a first state when subject to electrical power, and in a second state when not subject to electrical power.

8. The electrical extension cord of claim 7, wherein the power indicator is located within the housing and provides an external visual change in appearance when changing states.

9. The electrical extension cord of claim 6, wherein the first electrical cord and the second electrical cord have a length ranging from six feet to twelve feet.

10. The electrical extension cord of claim 6, wherein the power supply portion comprises an electrical connector directly coupled to the housing without the use of a power cord between the electrical connector and the housing.
